(19) United States
(12) Patent Application Publication
(10) Pub. No.: US 2025/0252423 A1
(43) Pub. Date: Aug. 7, 2025

(54) SYSTEMS AND METHODS OF REMOTELY ACTIVATED CARD-PRESENT PAYMENT TRANSACTIONS ON A GENERAL-PURPOSE MOBILE DEVICE

(71) Applicant: PLATFORM FACTORY INC, Burbank, CA (US)

(72) Inventors: Shalav Gupta, Burbank, CA (US); Spartak Buniatyan, Burbank, CA (US); Rashid Kamran, Burbank, CA (US)

(21) Appl. No.: 19/044,619

(22) Filed: Feb. 3, 2025

Related U.S. Application Data
(60) Provisional application No. 63/549,263, filed on Feb. 2, 2024.

(51) Int. Cl. G06Q 20/32

(52) U.S. Cl. CPC G06Q 20/3276; G06Q 20/3224; G06Q 20/3278

(57) ABSTRACT

A general-purpose mobile device includes a computer-readable storage medium, a wireless transceiver, a memory circuit, a card-present card reader configured to initiate a card-present payment transaction from a payment card using a card-present protocol, and a general-purpose processing circuit communicatively coupled to the storage medium, the wireless transceiver, the memory circuit, and the card-present card reader. The storage medium is dynamically configurable through the wireless transceiver to enable the processing circuit and the memory circuit to perform a variety of general-purpose computing tasks. The processing circuit is configured to receive a message from a point-of-sale terminal to remotely activate the card-present payment transaction, obtain payment information for the remotely activated card-present payment transaction from the payment card using the card reader, send the obtained payment information to a payment processor to process the card-present payment transaction, and receive payment confirmation for the processed card-present payment transaction from the payment processor.

### CROSS REFERENCE TO RELATED APPLICATION

The present application claims the benefit of U.S. Provisional Application No. 63/549,263, filed Feb. 2, 2024, the entire content of which is herein incorporated by reference.

### TECHNICAL FIELD

The present disclosure relates generally to payment transactions, and more particularly, to systems, methods, and programmable storage media for facilitating remotely activated card-present payment transactions on a general-purpose mobile device.

### BACKGROUND

Wireless tablets and laptops have facilitated merchants' ability to conduct transactions in customer homes and other point-of-sale locations remote from traditional places of business. This has increased the need for merchants to accept credit or debit card payments on the go, which presents some challenges. While manually entered credit or debit card processing is an option, these payments are penalized as “card not present” transactions by financial institutions due to the increased risk of abuse, misuse, and fraud inherent in such processing. This is in contrast to “card present” payment transactions, which use protocols and automated card-reading devices to lessen the risks of card-not-present transactions. Accordingly, card-present payment transactions incur significantly lower processing fees from financial institutions. Peripheral or dongle-based card readers can be attached or connected to merchants' portable computers to facilitate card-present transactions. However, such card reading devices increase the complexity of the merchants' portable computers and can be finicky or impractical because of maintenance and troubleshooting issues (such as charging and connectivity) associated with these devices. This combination of financial burden and operational inefficiency with current payment processing methods highlights the urgency for a more streamlined, cost-effective, and reliable payment solution.

Thus, there is a need for new systems and methods that can facilitate remotely activated card-present payment transactions.

### SUMMARY

In an embodiment of the present disclosure, a general-purpose mobile device is provided. The general-purpose mobile device includes a computer-readable storage medium, wireless transceiver, a memory circuit, a card-present card reader configured to initiate a card-present payment transaction from a payment card using a card-present protocol, and a general-purpose processing circuit communicatively coupled to the computer-readable storage medium, the wireless transceiver, the memory circuit, and the card-present card reader. The computer-readable storage medium is dynamically configurable through the wireless transceiver to enable the general-purpose processing circuit and the memory circuit to perform a variety of general-purpose computing tasks. The general-purpose processing circuit is configured to communicate with the wireless transceiver, the memory circuit, and the card-present card reader to: receive a message from a point-of-sale terminal to remotely activate the card-present payment transaction; obtain payment information for the remotely activated card-present payment transaction from the payment card using the card-present card reader; send the obtained payment information to a payment processor to process the card-present payment transaction; and receive payment confirmation for the processed card-present payment transaction from the payment processor.

In an aspect, the message is sent from the point-of-sale terminal to the general-purpose mobile device via a cloud-based interface that uses an application programming interface (API) call to deliver the message to the general-purpose mobile device as a push notification, and the general-purpose processing circuit is further configured to receive the delivered message through the API call to remotely activate the card-present payment transaction.

In an aspect, the card-present card reader includes a Europay, Mastercard, Visa (EMV) compliant card reader configured to obtain the payment information from the payment card using a near-field communication (NFC) protocol.

In a further aspect, the general-purpose mobile device is a smartphone, smartwatch, or NFC-equipped tablet, and the point-of-sale terminal is a wireless tablet or laptop.

In an aspect, the general-purpose processing circuit is further configured to forward the received payment confirmation to the point-of-sale terminal.

In an aspect, a system including the general-purpose mobile device and a server is provided. The memory circuit is a first memory circuit, the general-purpose processing circuit is a first general-purpose processing circuit, and the server includes a connection to a communications network, a second memory circuit, and a second general-purpose processing circuit communicatively coupled to the network connection and the second memory circuit. The second general-purpose processing circuit is configured to communicate with the network connection and the second memory circuit to: receive the message from the point-of-sale terminal; identify the general-purpose mobile device as a recipient of the received message; and forward the received message to the identified general-purpose mobile device. The first general-purpose processing circuit is further configured to receive the message from the point-of-sale terminal by receiving the forwarded message from the server to remotely activate the card-present payment transaction.

In an aspect of the system, the communications network is a cloud-based communications network, the second general-purpose processing circuit is further configured to use an application programming interface (API) call to forward the received message to the identified general-purpose mobile device as a push notification, and the first general-purpose processing circuit is further configured to receive the forwarded message through the API call to remotely activate the card-present payment transaction.

In an aspect of the system, the first general-purpose processing circuit is further configured to forward the received payment confirmation to the server, and the second general-purpose processing circuit is further configured to receive the forwarded payment confirmation from the general-purpose mobile device and forward the received forwarded payment confirmation to the point-of-sale terminal.

In an aspect of the system, the first general-purpose processing circuit is further configured to send the obtained payment information to the payment processor by sending the obtained payment information to the server, and the second general-purpose processing circuit is further configured to: receive the sent payment information from the general-purpose mobile device; forward the received payment information to the payment processor to process the card-present payment transaction; receive the payment confirmation for the processed card-present payment transaction from the payment processor; and forward the received payment confirmation to the general-purpose mobile device. The first general-purpose processing circuit is further configured to receive the payment confirmation for the card-present payment transaction from the payment processor by receiving the forwarded payment confirmation from the server.

In an aspect of the system: the second general-purpose processing circuit is further configured to determine an identification code that identifies the general-purpose mobile device, and to send the determined identification code to the general-purpose mobile device; the first general-purpose processing circuit is further configured to receive the sent identification code from the server, and to cause the received identification code to be displayed on the general-purpose mobile device in response to a request; and the second general-purpose processing circuit is further configured to identify the general-purpose mobile device as the recipient of the received message by receiving the requested identification code from the point-of-sale terminal as displayed on the general-purpose mobile device.

In an aspect of the system: the first general-purpose processing circuit is further configured to determine an identification code that identifies the general-purpose mobile device, send the determined identification code to the server, and cause the determined identification code to be displayed on the general-purpose mobile device in response to a request; and the second general-purpose processing circuit is further configured to receive the sent identification code from the general-purpose mobile device, and to identify the general-purpose mobile device as the recipient of the received message by receiving the requested identification code from the point-of-sale terminal as displayed on the general-purpose mobile device.

In an aspect of the system, the second general-purpose processing circuit is further configured to identify the general-purpose mobile device as the recipient of the received message by: causing the point-of-sale terminal to display a list of mobile devices, the displayed list of mobile devices including the general-purpose mobile device; and receiving, from the point-of-sale terminal, a selection of the general-purpose mobile device from among the displayed list of mobile devices.

In an aspect of the system: the second general-purpose processing circuit is further configured to identify the general-purpose mobile device as the recipient of the received message by determining a message code that identifies the received message, and causing the point-of-sale terminal to display the determined message code; the first general-purpose processing circuit is further configured to receive the message from the point-of-service terminal by causing the general-purpose mobile device to scan the displayed message code, and sending the scanned message code to the server; and the second general-purpose processing circuit is further configured to identify the general-purpose mobile device as the recipient of the received message by receiving the sent message code from the general-purpose mobile device.

In a further aspect of the system, the displayed message code is a bar code or a quick response (QR) code.

In an aspect of the system, the second general-purpose processing circuit is further configured to request a location of the general-purpose mobile device from the general-purpose mobile device, the first general-purpose processing circuit is further configured to respond to the request by determining the location of the general-purpose mobile device and sending the determined general-purpose mobile device location to the server, and the second general-purpose processing circuit is further configured to: receive the requested general-purpose mobile device location from the general-purpose mobile device; request a location of the point-of-sale terminal from the point-of-sale terminal; receive the requested point-of-sale terminal location from the point-of-sale terminal; and identify the general-purpose mobile device as the recipient of the received message by deciding that the point-of-sale terminal is within a proximity of the general-purpose mobile device using the received general-purpose mobile device location and the received point-of-sale terminal location.

In an aspect, a system including the general-purpose mobile device and the point-of-sale terminal is provided. The wireless transceiver is a first Bluetooth transceiver, the memory circuit is a first memory circuit, the general-purpose processing circuit is a first general-purpose processing circuit, and the point-of-sale terminal includes a second Bluetooth transceiver, a second memory circuit, and a second general-purpose processing circuit communicatively coupled to the second Bluetooth transceiver and the second memory circuit. The second general-purpose processing circuit is configured to communicate with the second Bluetooth transceiver and the second memory circuit to: identify the general-purpose mobile device; and send the message to the identified general-purpose mobile device using the second Bluetooth transceiver. The first general-purpose processing circuit is further configured to receive the message from the point-of-sale terminal using the first Bluetooth transceiver, to remotely activate the card-present payment transaction.

In another embodiment of the present disclosure, a method of remotely activating a card-present payment transaction on a general-purpose mobile device is provided. The method includes: receiving, at the general-purpose mobile device, a message from a point-of-sale terminal to remotely activate the card-present payment transaction; obtaining payment information for the remotely activated card-present payment transaction from a payment card using a card-present card reader at the general-purpose mobile device; sending, from the general-purpose mobile device, the obtained payment information to a payment processor to process the card-present payment transaction; and receiving, at the general-purpose mobile device, payment confirmation for the processed card-present payment transaction from the payment processor.

In an aspect of the method, the method further includes: sending, via a cloud-based interface, the message from the point-of-sale terminal to the general-purpose mobile device through an application programming interface (API) call to deliver the message to the general-purpose mobile device as a push notification; and receiving, at the general-purpose mobile device, the delivered message through the API call to remotely activate the card-present payment transaction.

In an aspect of the method, the method further includes: receiving, at a server, the message from the point-of-sale terminal; identifying, by the server, the general-purpose mobile device as a recipient of the received message; forwarding, from the server, the received message to the identified general-purpose mobile device; and receiving, at the general-purpose mobile device, the message from the point-of-sale terminal by receiving, at the general-purpose mobile device, the forwarded message from the server to remotely activate the card-present payment transaction.

In yet another embodiment of the present disclosure, a computer-readable storage medium having one or more instructions stored thereon, which when executed by at least one processor on a general-purpose mobile device, causes the general-purpose mobile device to: receive a message from a point-of-sale terminal to remotely activate a card-present payment transaction; obtain payment information for the remotely activated card-present payment transaction from a payment card using a card-present card reader at the general-purpose mobile device; send the obtained payment information to a payment processor to process the card-present payment transaction; and receive payment confirmation for the processed card-present payment transaction from the payment processor.

In still yet another embodiment of the present disclosure, a server is provided. The server includes a connection to a communications network, a memory circuit, and a processing circuit communicatively coupled to the network connection and the memory circuit. The processing circuit is configured to communicate with the network connection and the memory circuit to: receive a message from a point-of-sale terminal to remotely activate a card-present payment transaction on a general-purpose mobile device; identify the general-purpose mobile device as a recipient of the received message; and forward the received message to the identified general-purpose mobile device to remotely activate the card-present payment transaction on the general-purpose mobile device.

In an aspect of the server, the communications network is a cloud-based communications network, the processing circuit is further configured to use an application programming interface (API) call to forward the received message to the general-purpose mobile device as a push notification to remotely activate the card-present payment transaction on the general-purpose mobile device.

In an aspect of the server, the processing circuit is further configured to receive a payment confirmation for the card-present payment transaction from the general-purpose mobile device, and to forward the received payment confirmation to the point-of-sale terminal.

In an aspect of the server, the processing circuit is further configured to: receive, from the general-purpose mobile device, payment information obtained by the general-purpose mobile device for the remotely activated card-present payment transaction; forward the received payment information to a payment processor to process the card-present payment transaction; receive a payment confirmation for the processed card-present payment transaction from the payment processor; and forward the received payment confirmation to the general-purpose mobile device.

In an aspect of the server, the processing circuit is further configured to identify the general-purpose mobile device as the recipient of the received message by: determining an identification code that identifies the general-purpose mobile device; sending the determined identification code to the general-purpose mobile device to be displayed on the general-purpose mobile device; and receiving the sent identification code from the point-of-sale terminal as displayed on the general-purpose mobile device.

In an aspect of the server, the processing circuit is further configured to identify the general-purpose mobile device as the recipient of the received message by: receiving, from the general-purpose mobile device, an identification code that identifies the general-purpose mobile device and that is displayed on the general-purpose mobile device; and receiving, from the point-of-sale terminal, the received identification code as displayed on the general-purpose mobile device.

In an aspect of the server, the processing circuit is further configured to identify the general-purpose mobile device as the recipient of the received message by: causing the point-of-sale terminal to display a list of mobile devices, the displayed list of mobile devices including the general-purpose mobile device; and receiving, from the point-of-sale terminal, a selection of the general-purpose mobile device from among the displayed list of mobile devices.

In an aspect of the server, the processing circuit is further configured to identify the general-purpose mobile device as the recipient of the received message by: determining a message code that identifies the received message; causing the point-of-sale terminal to display the determined message code; and receiving, from the general-purpose mobile device, the displayed message code on the point-of-sale terminal as scanned by the general-purpose mobile device.

In a further aspect of the server, the displayed message code is a bar code or a quick response (QR) code.

In an aspect of the server, the processing circuit is further configured to identify the general-purpose mobile device as the recipient of the received message by: requesting a location of the general-purpose mobile device from the general-purpose mobile device; receiving the requested general-purpose mobile device location from the general-purpose mobile device; requesting a location of the point-of-sale terminal from the point-of-sale terminal; receiving the requested point-of-sale terminal location from the point-of-sale terminal; and deciding that the point-of-sale terminal is within a proximity of the general-purpose mobile device using the received general-purpose mobile device location and the received point-of-sale terminal location.

In still yet another embodiment of the present disclosure, a point-of-sale terminal is provided. The point-of-sale terminal includes a Bluetooth transceiver, a memory circuit, and a processing circuit communicatively coupled to the Bluetooth transceiver and the memory circuit. The processing circuit is configured to communicate with the Bluetooth transceiver and the memory circuit to: identify a general-purpose mobile device; and send, to the identified general-purpose mobile device using the Bluetooth transceiver, a message to remotely activate a card-present payment transaction on the general-purpose mobile device.

In an aspect of the point-of-sale terminal, the processing circuit is further configured to receive a payment confirmation for the card-present payment transaction from the general-purpose mobile device using the Bluetooth transceiver.

In still yet another embodiment of the present disclosure, a server-based method of remotely activating a card-present payment transaction on a general-purpose mobile device is provided. The method includes: receiving, at the server, a message from a point-of-sale terminal to remotely activate the card-present payment transaction on the general-purpose mobile device; identifying, at the server, the general-purpose mobile device as a recipient of the received message; and forwarding, from the server, the received message to the identified general-purpose mobile device to remotely activate the card-present payment transaction on the general-purpose mobile device.

In an aspect of the server-based method, the method further includes: receiving, at the server, a payment confirmation for the card-present payment transaction from the general-purpose mobile device; and forwarding, from the server, the received payment confirmation to the point-of-sale terminal.

In still yet another embodiment of the present disclosure, a point-of-sale terminal-based method of remotely activating a card-present payment transaction on a general-purpose mobile device is provided. The method includes: identifying the general-purpose mobile device at the point-of-sale terminal; and sending, to the identified general-purpose mobile device using a Bluetooth transceiver on the point-of-sale terminal, a message to remotely activate the card-present payment transaction on the general-purpose mobile device.

In an aspect of the point-of-sale terminal-based method, the method further includes receiving, at the point-of-sale terminal using the Bluetooth transceiver, a payment confirmation for the card-present payment transaction from the general-purpose mobile device.

### BRIEF DESCRIPTION OF THE DRAWINGS

FIG. 1 illustrates an example operating environment for remotely enabled card-present payment transactions on a general-purpose mobile device, according to an embodiment.

FIG. 2 illustrates an example flow diagram of a method for remotely activated card-present payment transactions on a general-purpose mobile device, according to an embodiment.

FIG. 3 illustrates an example flow diagram of a method for remotely activated card-present payment transactions on a general-purpose mobile device, according to another embodiment.

FIG. 4 illustrates an example flow diagram of a method for remotely activated card-present payment transactions on a general-purpose mobile device, according to yet another embodiment.

FIG. 5 illustrates an example general-purpose mobile device configured for remotely activated card-present payment transactions, according to an embodiment.

FIG. 6 illustrates an example method operational on a general-purpose mobile device for remotely activated card-present payment transactions, according to an embodiment.

FIGS. 7-10 illustrate example methods operational on a general-purpose mobile device and a server for implementing the remotely activated card-present payment transaction method of FIG. 6, according to one or more embodiments.

FIG. 11 illustrates an example method operational on a general-purpose mobile device and a server for implementing the remotely activated card-present payment transaction method of FIG. 7, according to an embodiment.

FIG. 12 illustrates an example method operational on a server for remotely activated card-present payment transactions, according to an embodiment.

FIG. 13 illustrates an example method operational on a point-of-sale terminal for remotely activated card-present payment transactions, according to an embodiment.

### DETAILED DESCRIPTION

In conjunction with the attached drawings, specific embodiments will now be described in detail to provide an understanding of various aspects of the disclosure to one of ordinary skill in the art. However, it will be understood by one of ordinary skill that these aspects may be practiced without these specific details. For example, electronic circuits may be shown in block diagrams to avoid obscuring the aspects in unnecessary detail. In other instances, well-known circuits, structures, and practices may be omitted or simplified so as not to obscure the aspects of the disclosure. As used herein, the term “aspects” does not require that all embodiments of the disclosure include the discussed feature, advantage, or mode of operation. In addition, a “card-present” transaction refers to a payment transaction in which a payment card's data is not entered manually to make a payment (e.g., the payment card data is automatically scanned or swiped, or obtained using a near-field communication (NFC) protocol). As used herein, the term “payment card” may refer to a physical credit, debit, or other financial card useful for making a secure payment, and/or any virtual manifestation of such a card possessing an equivalent card-present payment capability (such as a smartphone NFC version of the payment card).

### Overview

The present disclosure provides systems and methods of facilitating remotely activated card-present payment transactions. Such card-present payment transactions obtain the payment card data in a card-present fashion on a general-purpose mobile device (e.g., a smartphone or smartwatch using a near-field communication (NFC) protocol to scan the payment card). Such transactions are considered “remotely activated” when a computing device (e.g., point-of-sale terminal or server) other than the general-purpose mobile device takes part in initiating or activating the payment card reading on the general-purpose mobile device.

As discussed above, merchants engaging in on-the-go payment transactions using dedicated sales platforms (such as wireless or mobile tablets or laptops configured to support the merchants' products or services) may lack a convenient way to perform card-present payment transactions with customers. Most such sales platforms lack a dedicated or built-in NFC device, which greatly simplifies card-present payment transactions.

However, most on-the-go merchants carry smartphones that are NFC-equipped and are ideal card-present (e.g., tap to pay) payment transaction devices. Accordingly, in one example embodiment, such a payment transaction may be initiated at a point of sale (POS) device or terminal (such as a wireless tablet or laptop of a merchant) and carried out by a general-purpose mobile device (e.g., corresponding smartphone, smartwatch, or NFC-equipped tablet of the same merchant) that is remotely activated by the POS device or terminal. The remote activation works through a companion application on the general-purpose mobile device (e.g., smartphone app) to activate the general-purpose mobile device as a card-present transaction device (e.g., a tap-to-pay or other NFC-enabled payment device).

A “general-purpose” mobile device is a wireless device capable of being wirelessly dynamically configured with various applications (or apps) to enable a general-purpose processing circuit within the device to perform a variety of general-purpose computing tasks. Included in this dynamic configuring is the capability to load an app that turns the general-purpose mobile device into a payment terminal for card-present payment transactions. This is in contrast to a task-specific mobile device (such as a dedicated payment terminal) that is configured to perform only a single computing task (e.g., a payment terminal). Put another way, a general-purpose mobile device refers to a wireless mobile computing or electronic device that is designed for multiple functions beyond a specific predefined task. The general-purpose mobile device can run different applications, perform various operations, and be repurposed for multiple use cases. By contrast, a purpose-specific device is engineered to perform a single or narrowly defined function, typically with hardware or software constraints that prevent its use for other applications outside its intended scope.

In further detail, the POS device or terminal may be in proximity of (e.g., nearby) the payor or remote (e.g., a far distance) from the payor (such as at a merchant's office, but accessible through other communication channels such as voice or text). The POS device or terminal may send or cause to send (e.g., through a server) a cloud-based or network-based (such as Bluetooth) request to initiate a tap-to-pay transaction on the general-purpose mobile device. For example, the payment request may cause a cloud-based application programming interface (API) call to be sent to the general-purpose mobile device, such as through a cloud-activated companion application using a push notification. The payor is thus able to complete the transaction using a payment card (e.g., a physical card or electronic manifestation of such a card on the payor's smartphone) at the general-purpose mobile device in a card-present fashion. In one example embodiment, NFC-enabled general-purpose mobile devices (e.g., mobile phones, smartwatches, or tablets) may be used for payment and receive transaction initiation calls from existing Point-of-Sale (POS) systems, regardless of whether these systems are traditional, web-based, tablet device, or a combination thereof.

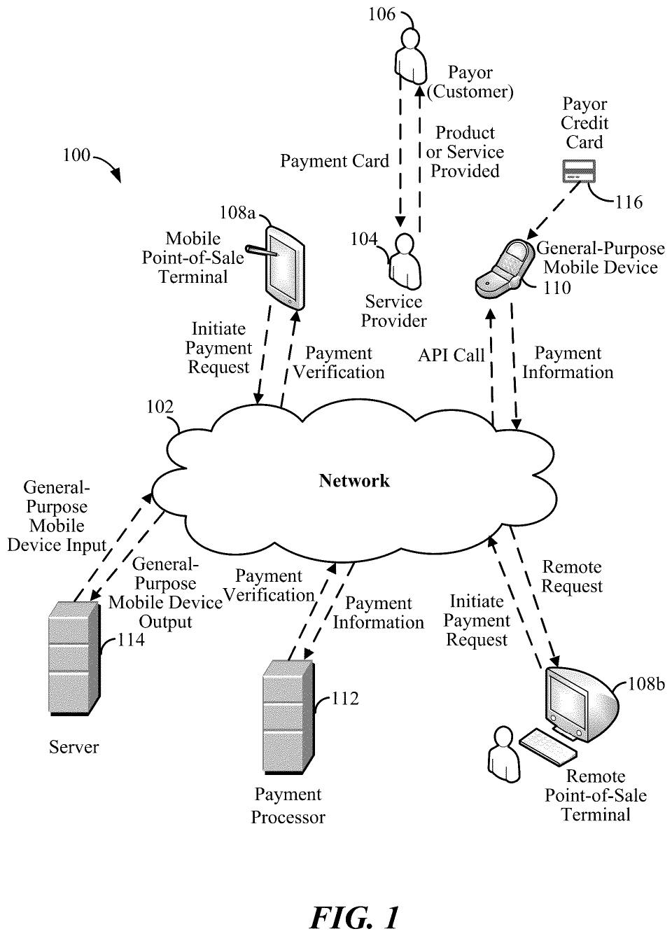

FIG. 1 illustrates an example operating environment 100 for remotely enabled card-present payment transactions on a general-purpose mobile device, according to an embodiment. The operating environment 100 may be designed for cloud-enabled card-present payment transactions and includes a network 102 (such as the Internet), a point-of-sale terminal (such as mobile point-of-sale terminal 108a and/or remote point-of-sale terminal 108b), a general-purpose mobile device 110 (such as a smartphone, smartwatch, or NFC-equipped tablet), a payment processor 112 (such as a third-party credit card transaction server), and/or a server 114. In various examples, the network 102 may include one or more wireless networks, one or more wired networks, and/or a point-to-point network.

A service provider 104 (such as a merchant) may provide a service or product to a customer/payor 106. To pay for the product or service, the payor 106 may provide a payment card 116 (such as a credit card or debit card, including a smartphone-enabled version of a physical card) to the service provider 104, who may then use a point-of-sale terminal (such as mobile POS tablet 108a or remote POS computer 108b) to initiate a tap-to-pay payment transaction. In one example, the service provider 104 may utilize a mobile POS 108a to initiate a payment request, which may cause a cloud-based API call (e.g., through server 114) to be sent to a general-purpose mobile device 110 (such as a merchant smartphone or smartwatch). The general-purpose mobile device 110 may use, for instance, a card reader or near-field communication (NFC) interface to read the payment card 116 using a card-present protocol and send payment information to the payment processor 112 (e.g., a third-party card payment transaction server). The payment processor 112 may then process the payment information and send a payment verification or confirmation (e.g., successful payment or failed payment) to the general-purpose mobile device 110. In an embodiment, the server 114 may be configured by code to select the payment processor 112 and act as a communications intermediary between the general-purpose mobile device 110 and the payment processor 112.

In one embodiment, the general-purpose mobile device 110 may be, for example, a mobile phone that executes a companion application upon receiving the API call to obtain payment card information and send the payment information to the payment processor 112. In an aspect, server 114 may be configured by code to identify the general-purpose mobile device 110 and send the payment request to the identified general-purpose mobile device 110 as an API call. In a further aspect, server 114 may be configured (e.g., by code) to function as a communications intermediary between mobile POS terminal 108a (and/or remote POS terminal 108b) and general-purpose mobile device 110. In an alternative approach, the service provider 104 may direct the remote POS 108b (e.g., via a text message or phone call) to send or cause to send the cloud-based API call to the general-purpose mobile device 110 to obtain payment from the payor.

In yet another example, the initiate payment request sent by the mobile POS terminal 108a may be received by a server (e.g., third party server or companion server interface, such as a web-based interface), which causes the API call to be generated and sent to the general-purpose mobile device 110. The specific destination information that allows the API call to be sent to general-purpose mobile device 110 may be, for example, provided by the POS terminal 108a and/or 108b, configured by the service provider 104, or pre-stored by the server 114 generating the API call.

In an embodiment, the general-purpose mobile device 110 runs a companion application configured (e.g., by code) to enable the general-purpose mobile device 110 to act as a card-present general-purpose mobile device at the activation of a remote signal (such as from server 114 or mobile POS terminal 108a). To this end, the general-purpose mobile device 110 includes a card-present transaction device or card reader, such as an NFC device, which allows the general-purpose mobile device 110 to automatically read or scan a payment card in a card-present manner. For instance, the general-purpose mobile device 110 may be configured through the NFC device to accept a tap-to-pay transaction from a customer's physical credit card or suitably equipped smartphone (e.g., using the customer's smartphone operating system and NFC capability to virtually appear as a credit card belonging to the customer in the tap-to-pay transaction).

In further detail, the general-purpose mobile device 110 may be configured by code and suitable hardware to become a card reader for a card-present payment transaction at the activation or initiation of a remote signal (i.e., from outside the general-purpose mobile device 110, as in from the mobile POS terminal 108a or the server 114). In an embodiment, the general-purpose mobile device 110 runs a companion application (or app) that pairs with a companion server application (such as on server 114). Upon loading the app on the general-purpose mobile device 110, the app may be configured to register the general-purpose mobile device 110 with the companion server application on server 114. This may include steps such as generating (e.g., on the general-purpose mobile device 110 or the server 114) an identification code for the general-purpose mobile device 110 that identifies the general-purpose mobile device 110, at least within confines of the server application. The generated identification code is then shared between the server 114 and the general-purpose mobile device 110. To this end, the identification code may include data that identifies the general-purpose mobile device (such as hardware- or software-specific data that is unique to the general-purpose mobile device 110) and may be stored on the server 114 as part of the server companion app.

In an aspect, the general-purpose mobile device 110 may display the identification code (or suitable identifying subset or representation of the identification code) in response to a request, such as a remotely generated request (e.g., from the mobile POS terminal 108a or server 114) or a locally generated request (e.g., a user interface (UI) generated request on the general-purpose mobile device 110). The displayed identification code can then be entered, for example, at the mobile point-of-sale terminal 108a (e.g., through a web-based companion server application on server 114 as interfaced through a browser on the mobile POS terminal 108a, or through a companion app on the mobile POS terminal 108a that directly communicates with general-purpose mobile device 110 via, e.g., a Bluetooth interface).

In an aspect, the server 114 may run a companion server application that is configured (e.g., by code) to maintain a database of registered mobile devices, such as general-purpose mobile device 110. The server 114 may run a companion server app that serves as an interface between the POS terminal (such as mobile POS terminal 108a) and the general-purpose mobile device 110 identified (or otherwise selected) to handle the card-present payment transaction. In an aspect, the companion server app may present a web-based (such as a browser) interface on the mobile POS terminal 108a that allows the POS terminal to interact with the general-purpose mobile device 110 without any special code on the POS terminal (other than a web browser) by going through the server 114. To this end, the server 114 (as configured by the companion server app) may convert a request of the POS terminal to initiate a card-present payment transaction into a corresponding API call to the general-purpose mobile device 110 sent with a push notification. The push notification can be a request to the companion app on the general-purpose mobile device 110 to present a card-present payment transaction window (such as a tap-to-pay screen) on the general-purpose mobile device 110 for the customer to tap a payment card 116 or smartphone.

In an embodiment, the POS terminal (such as mobile POS terminal 108a) runs a companion POS app that is configured to let the POS terminal communicate directly with the general-purpose mobile device 110 (e.g., such as by Bluetooth) to remotely activate the card-present payment transaction on the general-purpose mobile device 110 without using the server 114. In an embodiment, the general-purpose mobile device 110 itself can be used as a POS terminal by using a server-based implementation (e.g., on server 114) with a web-based POS terminal interface (e.g., a browser) running on the general-purpose mobile device 110. The card-present payment transaction would still be remotely activated (through server 114, such as by an API call from the server 114 to the general-purpose mobile device 110). This might be an unusual use, such as when the merchant's mobile tablet or laptop (POS terminal) is not available, with the merchant having to run their usual business POS application from their smartphone (which then gets to function as the general-purpose mobile device 110 via server 114 being the intermediary). In general, it should be assumed that the POS terminal and the general-purpose mobile device are separate devices.

Cloud API Integration: The general-purpose mobile device 110 may include a companion application that utilizes cloud APIs to initiate NFC-based payment transactions on the general-purpose mobile device 110. This integration allows for a flexible and adaptable payment process, compatible with a wide range of point-of-sale (POS) systems.

Device Flexibility and Integration: In one example, the companion application may function across various platforms, enabling remotely activated use on smartphones, tablets, and other web-enabled devices.

Push Notification Mechanism: Upon checkout or payment initiation on the POS terminal 108a or 108b, the service provider (e.g., technician or operator) may select a general-purpose mobile device (e.g., a target general-purpose mobile device) for remote activation from a list displayed on the POS terminal 108a/108b, triggering a push notification to the selected general-purpose mobile device 110 (e.g., the selected device) to initiate payment processing. The POS terminal 108a/108b may receive a notification, confirmation, or update once the payment is successfully completed or processed.

Scannable Code System: In one implementation, the mobile POS terminal 108a may display a code (such as a bar code or a quick response (QR) code) that identifies the payment transaction. The payment transaction code is then scanned by the general-purpose mobile device 110 (e.g., mobile phone or NFC-equipped tablet) to initiate the payment process. This ensures proximity of the general-purpose mobile device 110 to the mobile POS terminal 108a during the transaction, where that is a requirement or a desired method of transaction.

Other Proximity Verification Methods: Technologies like Bluetooth identification, direct Wi-Fi connections, and location technologies can be used to verify the general-purpose mobile device's 110 proximity to the mobile POS terminal 108a. By way of example, most mobile tablets and smartphones are capable of supplying their precise location when requested. Comparing these requested locations (such as through server 114) can then verify if the corresponding devices are within a desired proximity of one another.

Financial and Operational Benefits: By being able to physically process the payment card or equivalent (e.g., smartphone-enabled payment card), merchants benefit from the lower card-present processing fees compared to card-not-present rates. The system also reduces the need for additional hardware, lowering operational costs.

Enhanced User Experience: The described approach also streamlines the payment process for both merchants and customers by offering a quick, reliable, and integrated transaction experience.

Potential Applications: This cloud-activated tap-to-pay approach is applicable in various retail and service environments. It is particularly beneficial for merchants/vendors who are on the go, use cloud-based services and require a more integrated and efficient payment processing solution.

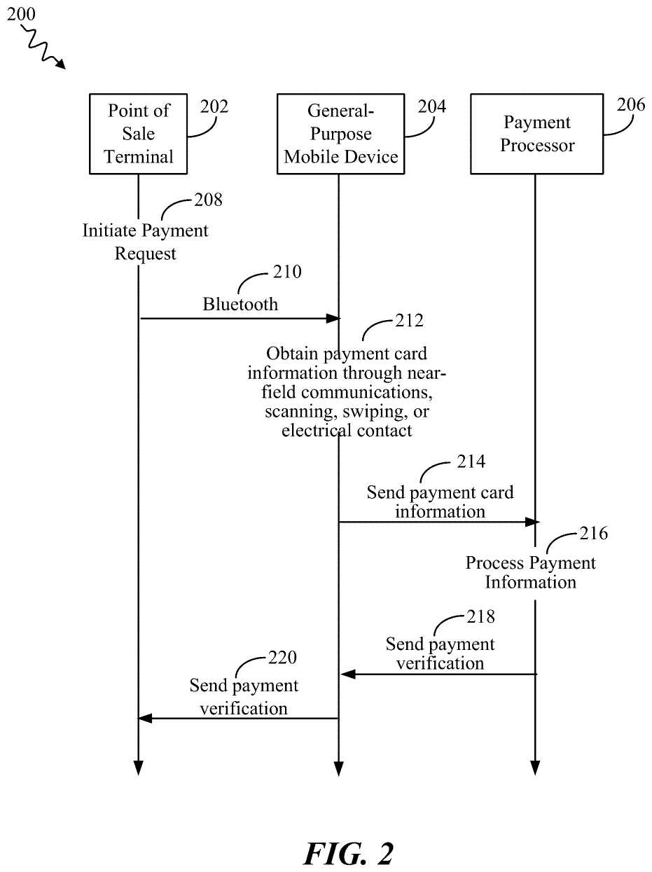

FIG. 2 illustrates an example flow diagram of a method 200 for remotely activated card-present payment transactions on a general-purpose mobile device, according to an embodiment. A point-of-sale terminal 202 (such as a mobile tablet or laptop) may serve to initiate a payment request 208. The point-of-sale terminal 202 may be located near the location in which the payment transaction is taking place. The point-of-sale terminal 202 may send a message (such as through a Bluetooth network 210) to a general-purpose mobile device 204 (such as a smartphone) to remotely activate the general-purpose mobile device 204 for processing the payment transaction. In turn, the general-purpose mobile device 204 may obtain payment card (e.g., credit card, debit card, or the like) information through a card-present technique, such as near-field communications, scanning, swiping, or electrical contact.

The general-purpose mobile device 204 may send the payment card information 214 to a payment processor 206 (e.g., a third-party server responsible for carrying out the payment transaction). The payment processor 206 may process 216 the sent payment information 214 as a card-present payment transaction and send a payment verification or confirmation 218 to the general-purpose mobile device 204. The payment verification 218 may indicate whether the payment was successfully processed or failed. In turn, the general-purpose mobile device 204 may forward the payment verification 220 to the point-of-sale terminal 202 to complete the payment transaction.

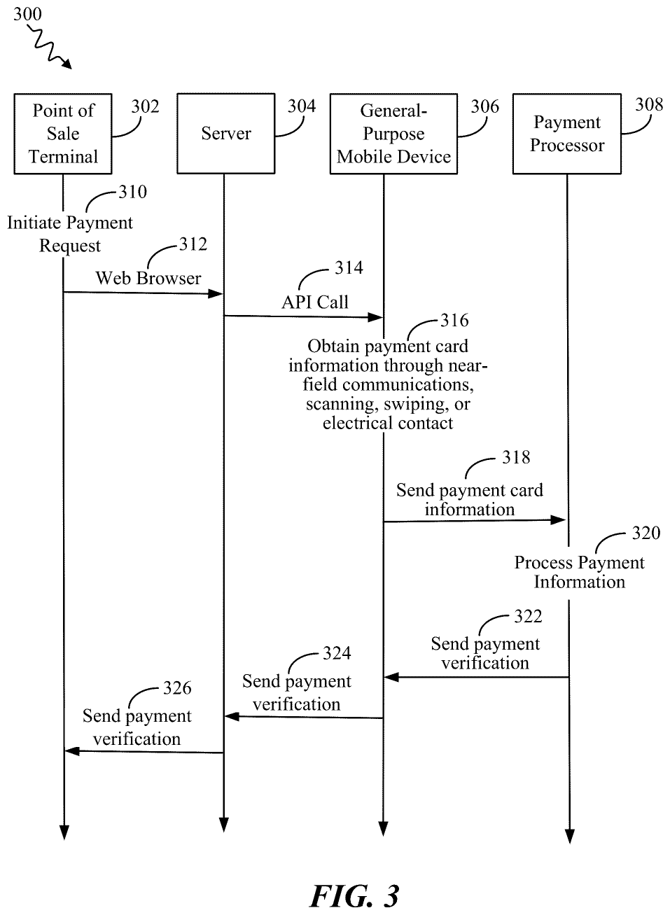

FIG. 3 illustrates an example flow diagram of a method 300 for remotely activated card-present payment transactions on a general-purpose mobile device, according to another embodiment. A point-of-sale terminal 202 (e.g., a merchant tablet) may serve to initiate a payment request 310. The point-of-sale terminal 302 may be located adjacent to or remote from the location in which the payment transaction is occurring. The point-of-sale terminal 302 is in communication with server 304, such as through a web browser 312. The point-of-sale terminal 302 may cause the server 304 to send an application programming interface (API) call 314 (e.g., a cloud-based message) to a general-purpose mobile device 306 (e.g., a merchant smartphone or smartwatch) to remotely activate the general-purpose mobile device 306 for use as a card-present payment transaction device. In turn, the general-purpose mobile device 306 may obtain payor (e.g., customer) payment card (e.g., credit card, debit card, or the like) information 316 through, for example, near-field communications, scanning, swiping, or electrical contact.

The general-purpose mobile device 306 may send the obtained payment card information 318 to a payment processor 308. The payment processor 308 may process the payment information 320 as a card-present payment transaction and send a payment verification or confirmation 322 to the general-purpose mobile device 306. The payment verification 322 may indicate whether the payment was successfully processed or failed. In turn, the general-purpose mobile device 306 may forward the payment verification 324 to the server 304, which may be configured by code to forward the payment verification 326 to the point-of-sale terminal 302 (such as by updating a web page being browsed by the point-of-sale terminal 302).

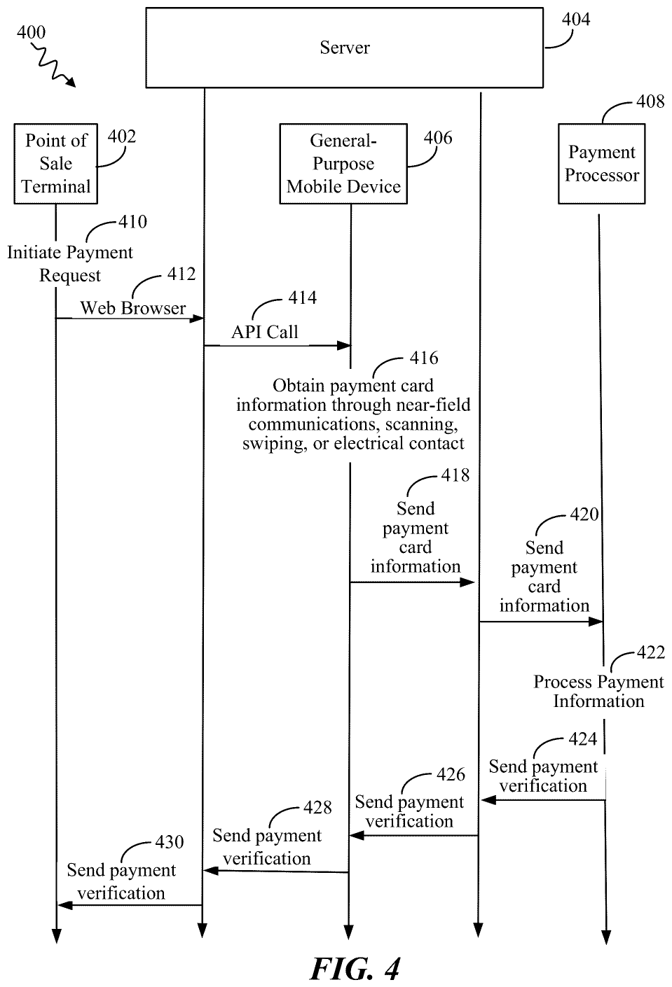

FIG. 4 illustrates an example flow diagram of a method 400 for remotely activated card-present payment transactions on a general-purpose mobile device, according to yet another embodiment. A point-of-sale terminal 402 (e.g., a merchant tablet) may serve to initiate a payment request 410. The point-of-sale terminal 402 may be located adjacent to or remote from the location in which the payment transaction is taking place. The point-of-sale terminal 402 is in communication with server 404, such as through a web browser 412. The point-of-sale terminal 402 may cause the server 404 to send an application programming interface (API) call 414 (e.g., a cloud-based message) to a general-purpose mobile device 406 (e.g., a merchant smartphone or NFC-equipped tablet) to remotely activate the general-purpose mobile device 406 for use as a card-present payment transaction device. In turn, the general-purpose mobile device 406 may obtain payor (e.g., customer) payment card (e.g., credit card, debit card, or the like) information 416 through, for example, near-field communications, scanning, swiping, or electrical contact.

The general-purpose mobile device 406 may send the obtained payment card information 418 to the server 404, which may choose a payment processor 408 for processing the payment transaction (e.g., based on factors such as cost, availability, appropriateness to process the particular payment transaction, to name a few). The server 404 may be configured by code to forward the payment card information 420 to the chosen payment processor 408 to process the card-present payment transaction. The payment processor 408 may process the payment information 422 as a card-present payment transaction and send a payment verification or confirmation 424 to the server 404. The server 404 may forward the payment verification 426 to the general-purpose mobile device 406. The forwarded payment verification 426 may indicate whether the payment was successfully processed or failed. In turn, the general-purpose mobile device 406 may forward the payment verification 428 to the server 404, which may be configured by code to forward the payment verification 430 to the point-of-sale terminal 402 (such as by updating a web page being browsed by the point-of-sale terminal 402).

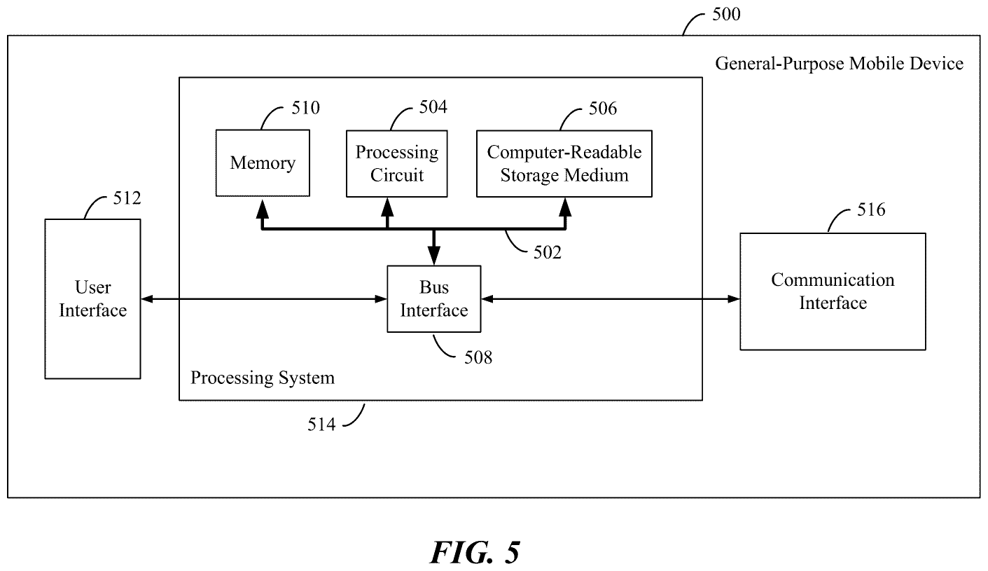

FIG. 5 illustrates an example general-purpose mobile device 500 configured for remotely activated card-present payment transactions, according to an embodiment. In one embodiment, the general-purpose mobile device 500 is configured for remotely activated (such as cloud-activated) card-present payment transactions. The general-purpose mobile device 500 may include a processing circuit 504, coupled to a computer-readable medium 506, a memory device 510, and a bus interface 508. The general-purpose mobile device 500 may also include a user interface 512 (e.g., display screen, touch screen, keypad, etc.) and a communication interface 516 (e.g., wireless interface, wired interface, near-field communication (NFC) interface, and/or card reader, etc.). In particular, the communication interface 516 may include a card-present transaction device (such as a Europay, Mastercard, Visa (EMV) compliant card reader) for performing the card-present payment transaction.

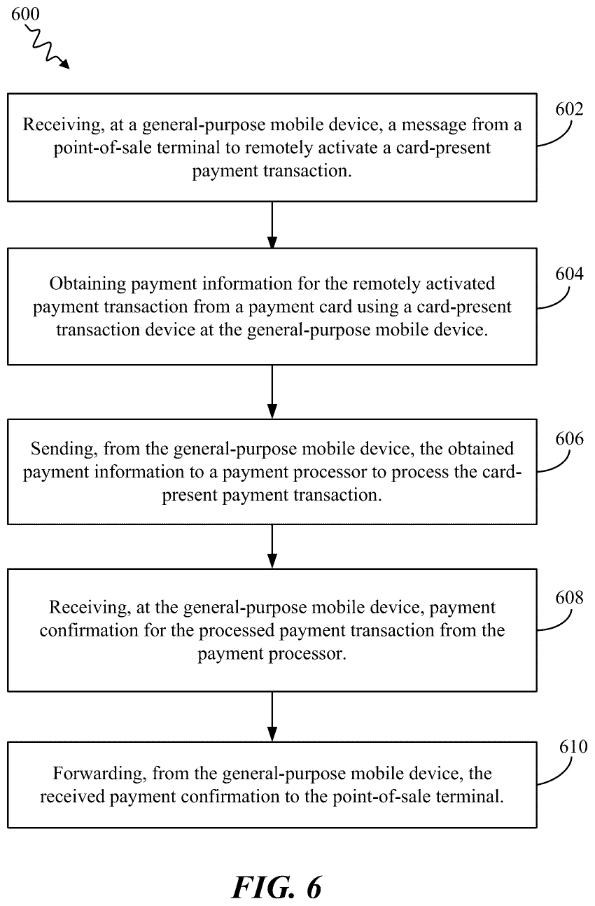

FIG. 6 illustrates an example method 600 operational on a general-purpose mobile device for remotely activated (such as cloud-activated) card-present payment transactions, according to an embodiment. While in this and other methods described herein, the various computing devices may be described as performing one or more actions, it is to be understood that in an actual implementation, these devices would be configured (such as being programmed by code) to carry out the actions.

In an application of method 600 carrying out one such card-present payment transaction, the general-purpose mobile device may receive 602 a cloud-based message from a point-of-sale terminal to remotely activate the card-present payment transaction. In response to receiving the message, the general-purpose mobile device may obtain 604 payment information for the remotely activated payment transaction from a payment card using a card-present transaction device at the general-purpose mobile device. For instance, the general-purpose mobile device may scan, read, or receive (e.g., near-field communications) a credit card from a payor. The general-purpose mobile device may send 606 the obtained payment information to a payment processor to process the card-present payment transaction. In response to sending the payment information, the general-purpose mobile device may receive 608 payment confirmation (e.g., success or failure) for the payment transaction from the payment processor. The general-purpose mobile device may forward 610 the payment confirmation to the point-of-sale terminal.

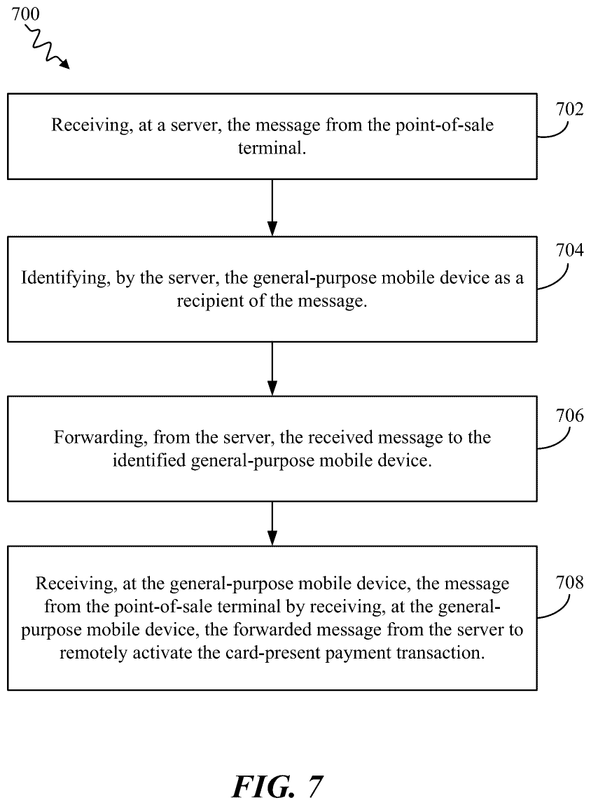

FIGS. 7-10 illustrate example methods 700, 800, 900, and 1000, respectively operational on a general-purpose mobile device and a server for implementing steps 602, 606, 608, and 610, respectively, of the remotely activated card-present payment transaction method 600 of FIG. 6, according to one or more embodiments. FIG. 7 corresponds to the general-purpose mobile device of FIG. 6 receiving 602 the message from the point-of-sale terminal to remotely activate the card-present payment transaction. In FIG. 7, the server may receive 702 the message from the point-of-sale terminal. The server may identify 704 the general-purpose mobile device as a recipient of the message. The server may then forward 706 the received message to the identified general-purpose mobile device. The general-purpose mobile device may then receive 708 the message from the point-of-sale terminal by receiving the forwarded message from the server to remotely activate the card-present payment transaction.

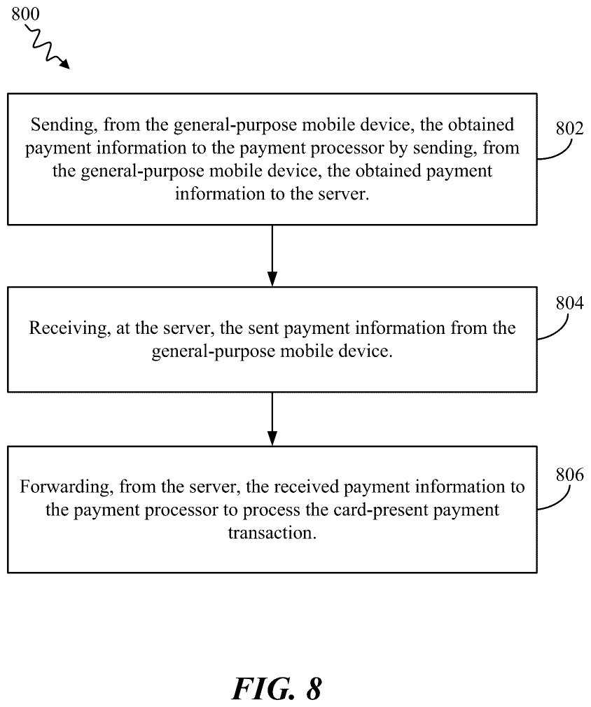

FIG. 8 corresponds to the general-purpose mobile device of FIG. 6 sending 606 the obtained payment information to the payment processor to process the card-present payment transaction. In FIG. 8, the general-purpose mobile device may send 802 the obtained payment information to the payment processor by sending the obtained payment information to the server. The server may then receive 804 the sent payment information from the general-purpose mobile device. The server may then forward 806 the received payment information to the payment processor to process the card-present payment transaction.

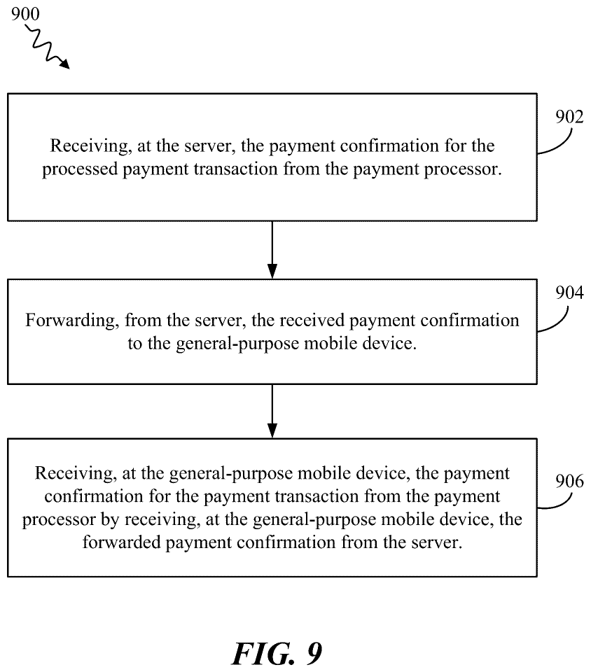

FIG. 9 corresponds to the general-purpose mobile device of FIG. 6, in response to sending the payment information, receiving 608 payment confirmation for the payment transaction from the payment processor. In FIG. 9, in response to the server forwarding the payment information, the server may receive 902 the payment confirmation for the payment transaction from the payment processor. The server may then forward 904 the received payment confirmation to the general-purpose mobile device. The general-purpose mobile device may then receive 906 the payment confirmation for the payment transaction from the payment processor by receiving the forwarded payment confirmation from the server.

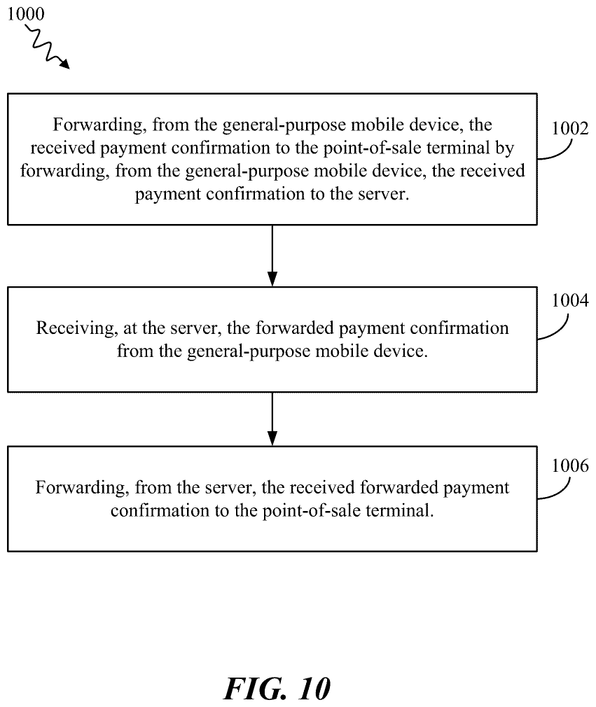

FIG. 10 corresponds to the general-purpose mobile device of FIG. 6 forwarding 610 the received payment confirmation to the point-of-sale terminal. In FIG. 10, the general-purpose mobile device may forward 1002 the received payment confirmation to the point-of-sale terminal by forwarding the received payment confirmation to the server. The server may then receive 1004 the forwarded payment confirmation from the general-purpose mobile device. The server may then forward 1006 the received forwarded payment confirmation to the point-of-sale terminal.

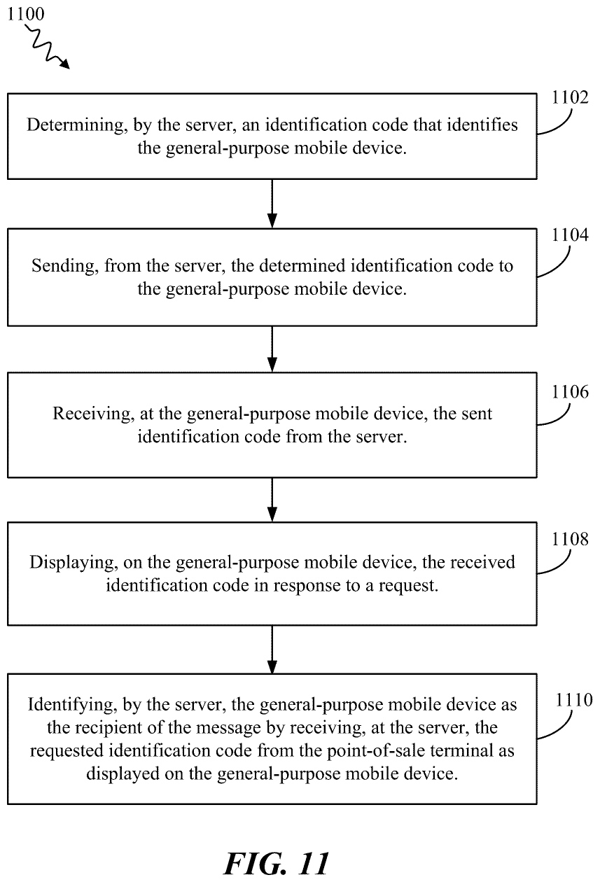

FIG. 11 illustrates an example method 1100 operational on a general-purpose mobile device and a server for implementing step 704 of the remotely activated card-present payment transaction method 700 of FIG. 7, according to an embodiment. FIG. 11 corresponds to the server of FIG. 7 identifying 704 the general-purpose mobile device as the recipient of the message. In FIG. 11, the server may determine 1102 an identification code that identifies the general-purpose mobile device. The server may then send 1104 the determined identification code to the general-purpose mobile device. The general-purpose mobile device may then receive 1106 the sent identification code from the server. The general-purpose mobile device may then display 1108 the received identification code in response to a request (such as a direct request from a user interface on the general-purpose mobile device, or a remote request from the point-of-sale terminal). The server may then identify 1110 the general-purpose mobile device as the recipient of the message by receiving the requested identification code from the point-of-sale terminal as displayed on the general-purpose mobile device (such as by entering the displayed identification code from a user interface on the point-of-sale terminal).

In a variation of the identifying method of FIG. 11, the general-purpose mobile device may determine an identification code that identifies the general-purpose mobile device, and then send the determined identification code to the server. The general-purpose mobile device may also display the determined identification code in response to a request. The server may in turn receive the sent identification code from the general-purpose mobile device, and identify the general-purpose mobile device as the recipient of the message by receiving the requested identification code from the point-of-sale terminal as displayed on the general-purpose mobile device.

In another identifying method, the server may identify the general-purpose mobile device as the recipient of the message by causing the point-of-sale terminal to display a list of mobile devices, where the displayed list of mobile devices includes the general-purpose mobile device. In addition, the server may receive, from the point-of-sale terminal, a selection of the general-purpose mobile device from among the displayed list of mobile devices.

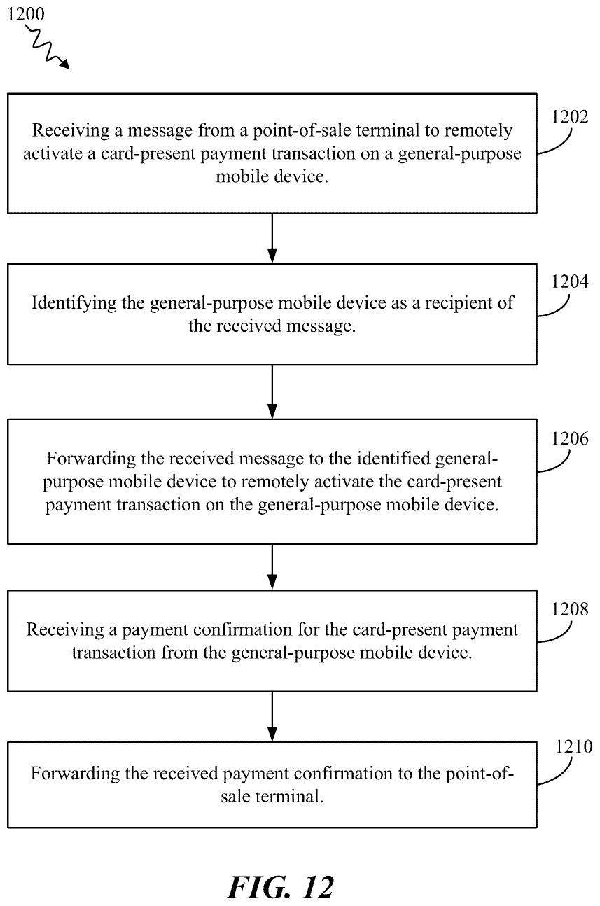

FIG. 12 illustrates an example method 1200 operational on a server for remotely activated card-present payment transactions, according to an embodiment. In an application of method 1200 carrying out one such card-present payment transaction, the server may receive 1202 a message from a point-of-sale terminal to remotely activate a card-present payment transaction on a general-purpose mobile device. The server may then identify 1204 the general-purpose mobile device as a recipient of the received message. The server may then forward 1206 the received message to the identified general-purpose mobile device to remotely activate the card-present payment transaction on the general-purpose mobile device. The server may then receive 1208 a payment confirmation for the card-present payment transaction from the general-purpose mobile device. The server may then forward 1210 the received payment confirmation to the point-of-sale terminal.

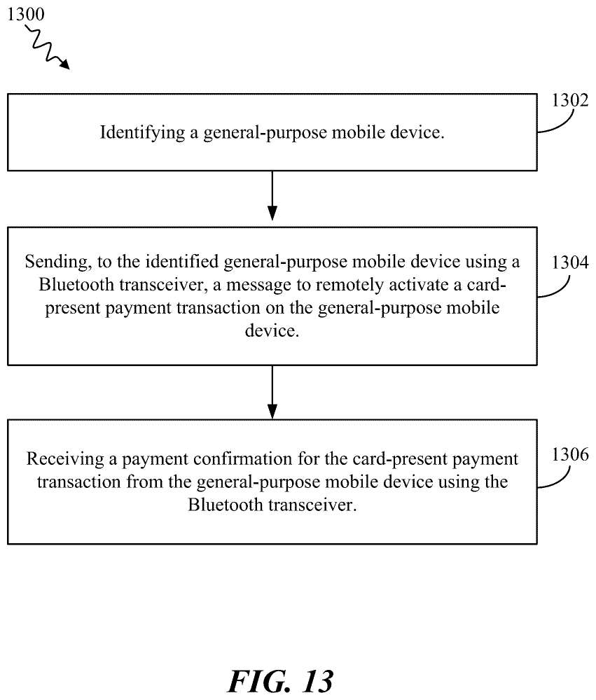

FIG. 13 illustrates an example method 1300 operational on a point-of-sale terminal (such as a merchant tablet) for remotely activated card-present payment transactions, according to an embodiment. In an application of method 1300 carrying out one such card-present payment transaction, the point-of-sale terminal may identify 1302 a general-purpose mobile device (such as a merchant smartphone communicatively coupled to the merchant tablet via a Bluetooth connection). The point-of-sale terminal may then send 1304, to the identified general-purpose mobile device using a Bluetooth transceiver, a message to remotely activate a card-present payment transaction on the general-purpose mobile device. The point-of-sale terminal may then receive 1306 a payment confirmation for the card-present payment transaction from the general-purpose mobile device using the Bluetooth transceiver.

In an embodiment, the general-purpose mobile device includes a card-present transaction device to obtain payment information for a card-present payment transaction from a payment card using a card-present protocol. In one aspect, the transaction device is a Europay, Mastercard, Visa (EMV) compliant card reader configured to obtain the payment information from the payment card using a near-field communication (NFC) protocol.

These and other embodiments will be apparent to one of ordinary skill with reference to the entire disclosure. It will be appreciated that many embodiments disclosed herein have further features that enhance their usefulness.

Convenience: Techniques described herein help eliminate the need for additional hardware, reducing the physical burden on merchants who are on the go. Also, such techniques help eliminate the need to manually enter card details.

Reliability: Additionally, the use of the general-purpose mobile device for performing the card-present payment transactions addresses the connectivity issues commonly faced with peripheral dongle-based systems. Tapped cards ensure that no mistypes of payment card information occur.

Cost-Effective: The card-present approaches disclosed herein also offer financial advantages with lower card-present transaction fees and reduced fraud exposure due to EMV liability shift from the merchant to the card issuer.

Enhanced Customer Experience: The disclosed techniques maintain the advantages of a POS interface for service presentation and engagement, while offering a smooth, integrated payment acceptance process on a convenient smartphone.

Security: Instead of manually entering card data, embodiments disclosed herein allow for payment cards to be tapped via contactless technology, which is more secure. In addition, proximity checks can help ensure the smartphone accepting payments is near the POS tablet or device, if that is a requirement or desired.

In an embodiment, a “Cloud-Activated Tap-to-Pay Companion Application” is provided for a general-purpose mobile device, such as a smartphone. The app represents a significant advancement in the field of payment processing, offering a versatile, user-friendly, cost-effective, and secure solution for merchants. This and other embodiments are well-aligned with the evolving needs of modern retail and service industries, providing a crucial link between traditional POS systems and cutting-edge payment technologies.

In an aspect, the Cloud-Activated Tap-to-Pay Companion Application may be implemented by software on the general-purpose mobile device. As used herein, software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable storage medium 506 of FIG. 5.

The computer-readable storage medium 506 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer (such as by the processing circuit 504). The computer-readable storage medium may also include, by way of example, a carrier wave, a transmission line, and any other suitable medium for transmitting software and/or instructions that may be accessed and read by a computer. The computer-readable storage medium 506 may reside in the processing system 514, external to the processing system 514, or distributed across multiple entities including the processing system 514. The computer-readable storage medium 506 may be embodied in a computer program product.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors (represented generally by the processing circuit 504, a memory 510, and the computer-readable media (represented generally by the computer-readable storage medium 506). The bus 502 may also link various other circuits such as timing sources, peripherals, voltage regulators, and power management circuits, which are well known in the art, and therefore, will not be described any further. A bus interface 508 provides an interface between the bus 502 and the communication interface 516. The communication interface 510 provides a means for communicating with other apparatuses over a transmission medium. Depending upon the nature of the apparatus, the user interface 312 (e.g., keypad, display, speaker, microphone, touchscreen display, etc.) may also be provided for the general-purpose mobile device 300.

One or more of the components, steps, features, and/or functions illustrated in FIGS. 1-11 may be rearranged and/or combined into a single component, step, feature or function or embodied in several components, steps, or functions. Additional elements, components, steps, and/or functions may also be added without departing from the scope of the disclosure. The apparatus, devices, and/or components illustrated in FIG. 5 may be configured to perform one or more of the methods, features, or steps described in FIGS. 1-4 and/or 6-11. The algorithms described herein may also be efficiently implemented in software and/or embedded in hardware.

Moreover, in one aspect of the disclosure, the processing circuit 504 illustrated in FIG. 5 may be a specialized processor (e.g., an application specific integrated circuit (e.g., ASIC)) that is specifically designed and/or hard-wired to perform the algorithms, methods, and/or steps described in FIGS. 1-4 and/or 6-11. Thus, such a specialized processor (e.g., ASIC) may be one example of a means for executing the algorithms, methods, and/or steps described in FIGS. 1-4 and/or 6-11. The computer-readable storage medium 506 may also store processing circuit 504 readable instructions that when executed by a specialized processor (e.g., ASIC) causes the specialized processor to perform the algorithms, methods, and/or steps described in FIGS. 1-4 and/or 6-11.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines, and/or devices.

Furthermore, aspects of the disclosure may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the disclosure described herein can be implemented in different systems without departing from the scope of the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A general-purpose mobile device comprising:
a computer-readable storage medium;
a wireless transceiver;
a memory circuit;
a card-present card reader configured to initiate a card-present payment transaction from a payment card using a card-present protocol; and
a general-purpose processing circuit communicatively coupled to the computer-readable storage medium, the wireless transceiver, the memory circuit, and the card-present card reader, the computer-readable storage medium being dynamically configurable through the wireless transceiver to enable the general-purpose processing circuit and the memory circuit to perform a variety of general-purpose computing tasks, the general-purpose processing circuit being configured to communicate with the wireless transceiver, the memory circuit, and the card-present card reader to:
receive a message from a point-of-sale terminal to remotely activate the card-present payment transaction;
obtain payment information for the remotely activated card-present payment transaction from the payment card using the card-present card reader;
send the obtained payment information to a payment processor to process the card-present payment transaction; and
receive payment confirmation for the processed card-present payment transaction from the payment processor.

2. The general-purpose mobile device of claim 1, wherein the message is sent from the point-of-sale terminal to the general-purpose mobile device via a cloud-based interface that uses an application programming interface (API) call to deliver the message to the general-purpose mobile device as a push notification, and the general-purpose processing circuit is further configured to receive the delivered message through the API call to remotely activate the card-present payment transaction.

3. The general-purpose mobile device of claim 1, wherein the card-present card reader comprises a Europay, Mastercard, Visa (EMV) compliant card reader configured to obtain the payment information from the payment card using a near-field communication (NFC) protocol.

4. The general-purpose mobile device of claim 3, wherein the general-purpose mobile device is a smartphone, smartwatch, or NFC-equipped tablet, and the point-of-sale terminal is a wireless tablet or laptop.

5. The general-purpose mobile device of claim 1, wherein the general-purpose processing circuit is further configured to forward the received payment confirmation to the point-of-sale terminal.

6. A system comprising the general-purpose mobile device of claim 1 and a server, wherein the memory circuit is a first memory circuit, the general-purpose processing circuit is a first general-purpose processing circuit, and the server comprises:
a connection to a communications network;
a second memory circuit; and
a second general-purpose processing circuit communicatively coupled to the network connection and the second memory circuit, the second general-purpose processing circuit being configured to communicate with the network connection and the second memory circuit to:
receive the message from the point-of-sale terminal;
identify the general-purpose mobile device as a recipient of the received message; and
forward the received message to the identified general-purpose mobile device,
wherein the first general-purpose processing circuit is further configured to receive the message from the point-of-sale terminal by receiving the forwarded message from the server to remotely activate the card-present payment transaction.

7. The system of claim 6, wherein the communications network is a cloud-based communications network, the second general-purpose processing circuit is further configured to use an application programming interface (API) call to forward the received message to the identified general-purpose mobile device as a push notification, and the first general-purpose processing circuit is further configured to receive the forwarded message through the API call to remotely activate the card-present payment transaction.

8. The system of claim 6, wherein the first general-purpose processing circuit is further configured to forward the received payment confirmation to the server, and the second general-purpose processing circuit is further configured to receive the forwarded payment confirmation from the general-purpose mobile device and forward the received forwarded payment confirmation to the point-of-sale terminal.

9. The system of claim 6, wherein the first general-purpose processing circuit is further configured to send the obtained payment information to the payment processor by sending the obtained payment information to the server, and the second general-purpose processing circuit is further configured to:
receive the sent payment information from the general-purpose mobile device;
forward the received payment information to the payment processor to process the card-present payment transaction;
receive the payment confirmation for the processed card-present payment transaction from the payment processor; and
forward the received payment confirmation to the general-purpose mobile device,
wherein the first general-purpose processing circuit is further configured to receive the payment confirmation for the card-present payment transaction from the payment processor by receiving the forwarded payment confirmation from the server.

10. The system of claim 6, wherein:
the second general-purpose processing circuit is further configured to determine an identification code that identifies the general-purpose mobile device, and to send the determined identification code to the general-purpose mobile device;
the first general-purpose processing circuit is further configured to receive the sent identification code from the server, and to cause the received identification code to be displayed on the general-purpose mobile device in response to a request; and
the second general-purpose processing circuit is further configured to identify the general-purpose mobile device as the recipient of the received message by receiving the requested identification code from the point-of-sale terminal as displayed on the general-purpose mobile device.

11. The system of claim 6, wherein:
the first general-purpose processing circuit is further configured to determine an identification code that identifies the general-purpose mobile device, send the determined identification code to the server, and cause the determined identification code to be displayed on the general-purpose mobile device in response to a request; and
the second general-purpose processing circuit is further configured to receive the sent identification code from the general-purpose mobile device, and to identify the general-purpose mobile device as the recipient of the received message by receiving the requested identification code from the point-of-sale terminal as displayed on the general-purpose mobile device.

12. The system of claim 6, wherein the second general-purpose processing circuit is further configured to identify the general-purpose mobile device as the recipient of the received message by:
causing the point-of-sale terminal to display a list of mobile devices, the displayed list of mobile devices including the general-purpose mobile device; and
receiving, from the point-of-sale terminal, a selection of the general-purpose mobile device from among the displayed list of mobile devices.

13. The system of claim 6, wherein:
the second general-purpose processing circuit is further configured to identify the general-purpose mobile device as the recipient of the received message by determining a message code that identifies the received message, and causing the point-of-sale terminal to display the determined message code;
the first general-purpose processing circuit is further configured to receive the message from the point-of-service terminal by causing the general-purpose mobile device to scan the displayed message code, and sending the scanned message code to the server; and
the second general-purpose processing circuit is further configured to identify the general-purpose mobile device as the recipient of the received message by receiving the sent message code from the general-purpose mobile device.

14. The system of claim 13, wherein the displayed message code is a bar code or a quick response (QR) code.

15. The system of claim 6, wherein the second general-purpose processing circuit is further configured to request a location of the general-purpose mobile device from the general-purpose mobile device, the first general-purpose processing circuit is further configured to respond to the request by determining the location of the general-purpose mobile device and sending the determined general-purpose mobile device location to the server, and the second general-purpose processing circuit is further configured to:
receive the requested general-purpose mobile device location from the general-purpose mobile device;
request a location of the point-of-sale terminal from the point-of-sale terminal;
receive the requested point-of-sale terminal location from the point-of-sale terminal; and
identify the general-purpose mobile device as the recipient of the received message by deciding that the point-of-sale terminal is within a proximity of the general-purpose mobile device using the received general-purpose mobile device location and the received point-of-sale terminal location.

16. A system comprising the general-purpose mobile device and the point-of-sale terminal of claim 1, wherein the wireless transceiver is a first Bluetooth transceiver, the memory circuit is a first memory circuit, the general-purpose processing circuit is a first general-purpose processing circuit, and the point-of-sale terminal comprises:
a second Bluetooth transceiver;
a second memory circuit; and
a second general-purpose processing circuit communicatively coupled to the second Bluetooth transceiver and the second memory circuit, the second general-purpose processing circuit being configured to communicate with the second Bluetooth transceiver and the second memory circuit to:
identify the general-purpose mobile device; and
send the message to the identified general-purpose mobile device using the second Bluetooth transceiver,
wherein the first general-purpose processing circuit is further configured to receive the message from the point-of-sale terminal using the first Bluetooth transceiver, to remotely activate the card-present payment transaction.

17. A method of remotely activating a card-present payment transaction on a general-purpose mobile device, comprising:
receiving, at the general-purpose mobile device, a message from a point-of-sale terminal to remotely activate the card-present payment transaction;
obtaining payment information for the remotely activated card-present payment transaction from a payment card using a card-present card reader at the general-purpose mobile device;
sending, from the general-purpose mobile device, the obtained payment information to a payment processor to process the card-present payment transaction; and
receiving, at the general-purpose mobile device, payment confirmation for the processed card-present payment transaction from the payment processor.

18. The method of claim 17, further comprising:
sending, via a cloud-based interface, the message from the point-of-sale terminal to the general-purpose mobile device through an application programming interface (API) call to deliver the message to the general-purpose mobile device as a push notification; and
receiving, at the general-purpose mobile device, the delivered message through the API call to remotely activate the card-present payment transaction.

19. The method of claim 17, further comprising:
receiving, at a server, the message from the point-of-sale terminal;
identifying, by the server, the general-purpose mobile device as a recipient of the received message;
forwarding, from the server, the received message to the identified general-purpose mobile device; and
receiving, at the general-purpose mobile device, the message from the point-of-sale terminal by receiving, at the general-purpose mobile device, the forwarded message from the server to remotely activate the card-present payment transaction.

20. A computer-readable storage medium having one or more instructions stored thereon, which when executed by at least one processor on a general-purpose mobile device, causes the general-purpose mobile device to:
receive a message from a point-of-sale terminal to remotely activate a card-present payment transaction;
obtain payment information for the remotely activated card-present payment transaction from a payment card using a card-present card reader at the general-purpose mobile device;
send the obtained payment information to a payment processor to process the card-present payment transaction; and
receive payment confirmation for the processed card-present payment transaction from the payment processor.
